(19) United States
(12) Patent Application Publication
(10) Pub. No.: US 2017/0028806 A1
(43) Pub. Date: Feb. 2, 2017

(54) DEVICE FOR LOWERING THE BODY OF A VEHICLE INCLUDING A MEANS FOR DETECTING THE HIGH POSITION

(71) Applicant: SOCIETE INDUSTRIELLE DE PREFABRICATION ELECTRIQUE SIPREL, LOZANNE (FR)

(72) Inventor: Xavier POURCHON, Lozanne (FR)

(21) Appl. No.: 15/160,177

(22) Filed: May 20, 2016

(30) Foreign Application Priority Data
May 22, 2015 (FR) 15/54628

(51) Int. Cl. B60G 17/017; B60G 17/005

(52) U.S. Cl. CPC B60G 17/017; B60G 17/005

(57) ABSTRACT

A device for lowering the body of a vehicle, including an arm (40) receiving the hub of a wheel of an axle (24) supporting the body of the vehicle, this arm being pivotally fastened on the axle so as to raise or lower the hub relative to the axle under the effect of an actuator (10), this device including a locking system (30) which automatically blocks the pivot arm in its end-of-travel position with the body raised, this device including a means (100) for detecting the end-of-travel position of the pivot arm (40) with the body raised.

### CROSS REFERENCE TO RELATED APPLICATION

This application is related to and claims the benefit of French Patent Application Number 15/54628 filed on 22 May 2015, the contents of which are herein incorporate by reference in their entirety.

### TECHNICAL FIELD

The present invention concerns a device for lowering the motor vehicle body, as well as a motor vehicle quipped with such a lowering device.

### BACKGROUND

Some motor vehicles, in particular utility vehicles used for the transportation of disabled persons in a wheelchair, or for the transportation of some goods, include a device for lowering the body relative to the axles so as to present a very low loading sill.

Thus, it is possible in particular to lower the rear of the body of a pick-up truck in order to obtain a floor close to the ground at the level of the sill of the rear doors, thereby allowing to use a slightly inclined ramp for facilitating the boarding of a disabled person sitting on its wheelchair. Similarly, it is possible to use such a device to facilitate passage of carriages supporting parcels, when climbing a reduced step.

A known type of a device for lowering the body of the vehicle, presented in particular in document FR-A1-2623755, includes, on each side of a cross-member of the rear axle of the vehicle, a substantially vertical mast, supporting in an intermediate portion a transverse axis receiving a pivot arm, and at an upper portion, the end of a telescopic hydraulic cylinder which, when deploying, makes a side of this pivot arm tilt downwards.

The other side of the pivot arm receiving the hub of a rear wheel then tilts upwards at the same time, which results in a descent of the axle cross-member relative to this wheel, and therefore of the body linked to this cross-member by the suspension.

Conversely, by a retraction of the hydraulic cylinder, the pivot arm is tilted in the other direction, which pulls up the cross-member and the body of the vehicle relative to the wheel. At the end of the motion, a hook linked to the vertical mast automatically hooks on the pivot arm so as to hold it blocked in the position where the body of the vehicle is fully raised, allowing rolling of this vehicle presenting a normal height, with a proper operation of the suspension.

Nonetheless, it is exceptionally possible, for example after insertion of foreign bodies in the lowering device such as grit projected during rolling, to obtain an incorrect position of the pivot arm which has not performed its full travel of raising the body, and an insufficient locking of its hook. There is then a risk that the vehicle starts by taking the road with a side of the body which is not fully raised, or a risk of collapse of this body during rolling due to incorrect locking, which may result in damages, or even in an accident.

### BRIEF SUMMARY

The present invention aims in particular to avoid these drawbacks of the prior art.

To this end, it proposes a device for lowering the body of a vehicle, including an arm receiving the hub of a wheel of an axle supporting the body of the vehicle, this arm being pivotally fastened on the axle so as to raise or lower the hub relative to the axle under the effect of an actuator, this device including a locking system which automatically blocks the pivot arm in its end-of-travel position with the body raised, this device being remarkable in that it includes a means for detecting the end-of-travel of the pivot arm with the body raised.

One advantage of this device for lowering the body of the vehicle is that the detection means connected to a driver information means, or to a safety means for example preventing the rolling, allows checking that the pivot arm has reached its end-of-travel, which guarantees the operation of the automatic locking system holding this arm in this position. Safety is then ensured with the vehicle rolling with its normal body height.

The device for lowering the body of a vehicle according to the invention may include one or more of the following features, which may be combined together.

According to one embodiment, the detection means establishes an electric contact when detecting the end-of-travel position of the pivot arm. Then, we have a simple information which can be easily exploited.

Advantageously, the detection means is fastened on the lowering device by a position setting system. It is possible to accurately adjust the detection of the end-of-travel of the pivot arm.

In this case, the position setting system advantageously includes elongated holes receiving fastening screws of the detection means, which extend substantially in the direction of motion of the portion linked to the pivot arm, when it comes over this detection means.

In particular, the detection means may be fastened on an adjustable abutment forming the end-of-travel abutment of the pivot arm. In this manner, a displacement of the abutment for its setting results in an equivalent displacement of the detection means.

The detection means may include a detection finger which receives the push of an element linked to the pivot arm when it reaches the end-of-travel.

According to one embodiment, the lowering device includes a shaft disposed transversally in the vehicle, supporting at its end facing outwardly of the vehicle the pivot arm, and at its inner end a crank receiving the motion of the actuator and acting on the detection means.

Advantageously, the locking system includes an additional detector which detects its position achieving the blocking of the pivot arm at the end-of-travel. In this manner, the positioning of the locking system blocking the pivot arm at the end-of-travel is confirmed.

Advantageously, the lowering device includes a control cable which opens the locking system. This cable constitutes a simple and economical means for opening the locking system.

A motor vehicle is herein described which is equipped with a device for lowering the body of this vehicle, including any one of the preceding features.

Advantageously, the detection means is connected to an electric circuit for checking the handbrake of the vehicle in the clamped position, so as to operate the signal of this handbrake intended to the driver when the end-of-travel position of the pivot arm is not detected.

### BRIEF DESCRIPTION OF THE DRAWINGS

The invention will be better understood and other features and advantages will appear more clearly upon reading the description hereinafter given as example, with reference to the appended drawings in which:

FIG. 1 is a view, at one side of the axle, of a device for lowering the body of a vehicle according to the document of the prior art presented hereinabove;

FIGS. 2 and 3 are respectively side and front views of a device for lowering the body according to the invention, this body being in the high position;

FIG. 4 is a side view of this device, the body being in the low position; and

FIGS. 5 and 6 are respectively side and profile views of the position sensor of the pivot arm of this device.

### DETAILED DESCRIPTION

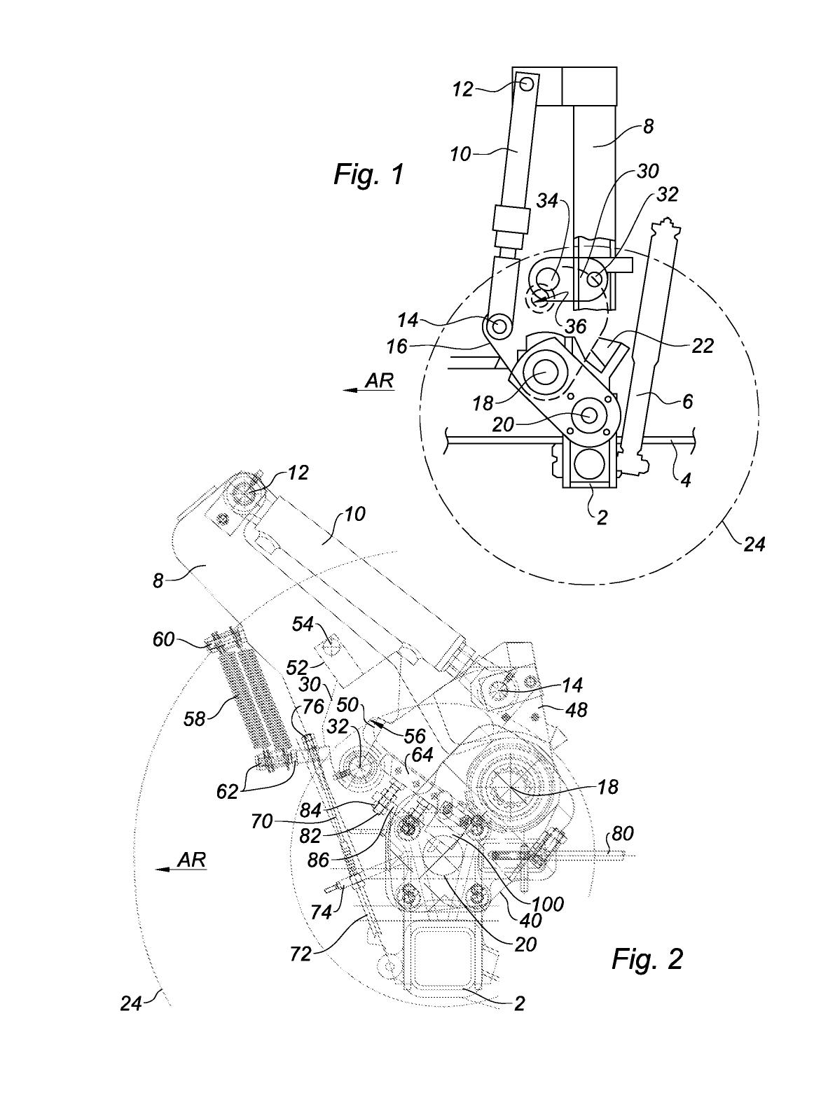

FIG. 1 presents a rear axle of a vehicle including a cross-member 2 linked on each side to the body of this vehicle by a longitudinal suspension leaf 4, and a telescopic hydraulic damper 6. One side, conventionally called rear side, is indicated in the figure by the arrow denoted as <<AR>>.

Each end of the cross-member 2 receives a device for lowering the body of the vehicle, comprising a substantially vertical mast 8 fastened to this cross-member. A pivot arm 16 includes in its central portion a pivot 18 fastened to the lower portion of the mast 8, slightly to the rear of this mast. The front portion of the pivot arm 16 includes holes 20 receiving the hub of a rear wheel of the vehicle 24.

A telescopic hydraulic cylinder 10 substantially vertically disposed, includes its upper end linked via a pivot 12 to the tip of the mast 8, and its lower end linked via another pivot 14 to the rear portion of the pivot arm 16.

In the retracted position of the cylinder 10 presented in FIG. 1, the rear portion of the pivot arm 16 is raised while bearing on a abutment 22, the front portion as well as the wheel it supports 24 being then lowered. The body of the vehicle is in its normal rolling high position. In the deployed position of the cylinder 10, the rear portion of the pivot arm 16 is lowered, the front portion 20 as well as the wheel 24 are then raised, which gives the low position of the body of the vehicle intended for the loading.

When the cylinder 10 retracts to pull up the body of the vehicle, the rear portion of the pivot arm 16 includes a recess 36 which, at the end-of-travel, automatically fits in a finger 34 of a hook 30 pivoting about a front axis 32, in order to hold the high position of the locked body.

Moreover, the lowering device includes a means for unlocking the hook 30, allowing to make it tilt after having released the pressure of the arm 16 on the finger 34 of this hook, so as to allow the cylinder 10 to deploy again.

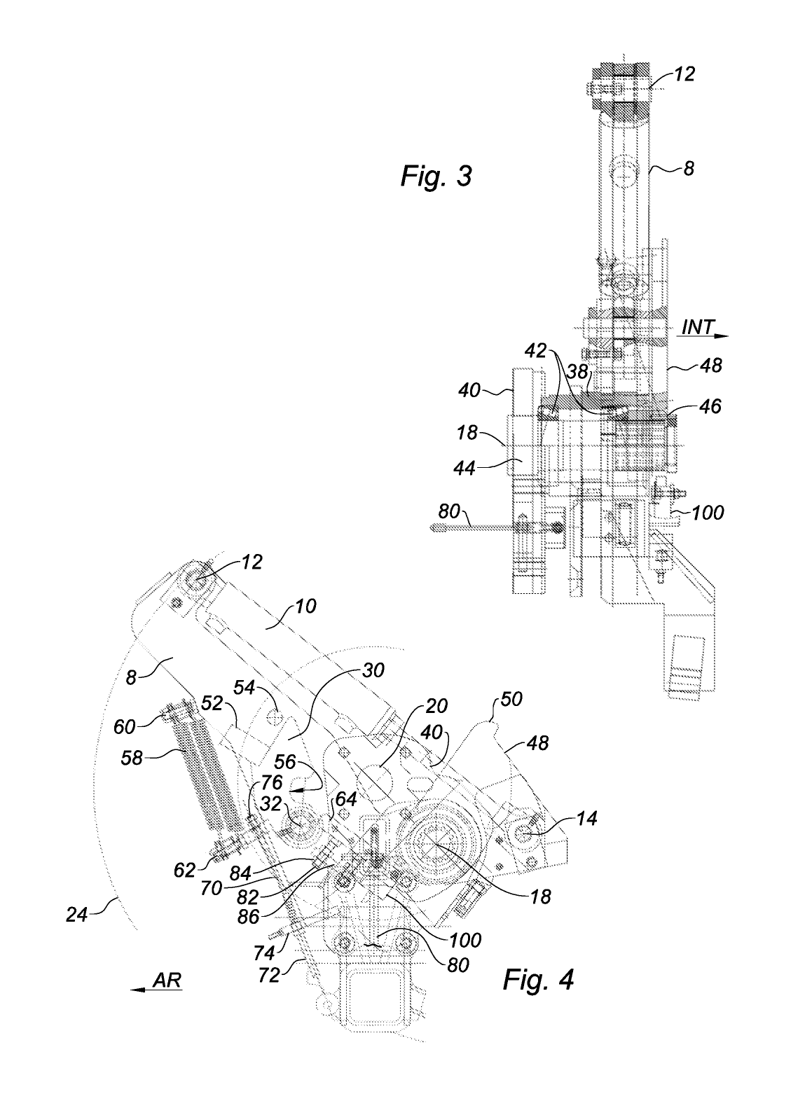

FIGS. 2 and 3 present the mast 8 formed by two parallel metal sheets disposed longitudinally in the vehicle, welded to the cross-member 2 of the rear axle, receiving in the lower portion a welded transverse tube 38 so as to form the pivot 18. In FIG. 3, the inner side of the vehicle is indicated by the arrow denoted as <<INT>>.

The transverse tube 38 includes thereinside two tapered roller bearings 42 guiding a shaft 44, receiving at its external end a pivot arm 40 formed by a metal sheet, which extends in an inclined manner rearward and downward, its rear end presenting the holes 20 receiving the hub of the wheel 24.

The internal end of the shaft 44 includes grooves receiving a hub 46 supporting an internal pivot crank 48 formed by a metal sheet, which extends upwards. In this manner, the external pivot arm 40 and the internal crank 48 are rotatably linked via the shaft 44.

The telescopic hydraulic cylinder 10 has the upper end of its body linked to the mast 8 via the pivot 12, and the lower end of its rod linked to the internal crank 48 via the pivot 14. In this manner, the cylinder 10 positions the axis of the wheel 24 downwards when it is retracted, and upwards when lowering the body of the vehicle, after its deployment resulting in a rotation of the shaft 44 by about one quarter turn clockwise, as presented in FIG. 4.

An adjustable high abutment 64 fastened on the mast 8 includes a planar portion against which bears a straight edge of the metal sheet of the crank 48 so as to block it at the end-of-travel when it is raised, which sets the high position of the body of the vehicle.

A hook 30 formed by a metal sheet, and fastened on the inner side of the mast 8 by a transverse pivot 32, includes a recess 56 facing the pivot of the crank 18. The rear side of the hook 30 includes a lower axis 62 receiving two parallel tension springs 58 fastened upwardly to the mast 8 by an upper axis 60, permanently exerting a rotational torque on this hook in the clockwise direction.

When the cylinder 10 retracts while pulling up the crank 48 so as to raise the vehicle, the finger 50 of this crank first lifts up the hook 30. At the end-of-travel of the crank 48, when it bears against the abutment 64, the hook 30 is automatically lowered under the effect of the springs 58 while letting the finger 50 fall in the recess 56 so as to lock the position of this crank.

The device for lowering the vehicle is then blocked and secured with the body of the vehicle in the high position, the hydraulic pressure in the cylinder 10 may be held or suppressed, without modifying the locking of this device.

A cylindrical presence detector 54 is engaged in two aligned holes of the metal sheets of the mast 8, its active end facing a boss 52 fastened on the hook 30, disposed radially outwards with respect to the pivot 18, in order to detect the position of this hook when it is engaged on the locking finger 50.

An unlocking cable 70 slides in a sheath 72 the end of which is held by a stop 74 fastened to the mast 8, so as to pull by its adjustable end 76 on the lower axis 62 fastened to the hook 30 and holding the springs 58, in order to lift up this hook so as to perform the unlocking of the finger 50.

In order to descend the body of the vehicle, it is necessary to pull on the unlocking cable 70, and simultaneously apply a hydraulic pressure in the cylinder 10 in the retraction direction so as to take off the weight of the body on the finger 50 engaged in the hook 30, which releases this hook and allows it to lift up.

The rear axle of the vehicle includes a handbrake cable 80 which is fastened to the internal pivot arm 40, in order to control the brake of the rear wheel disposed on this side in the usual manner.

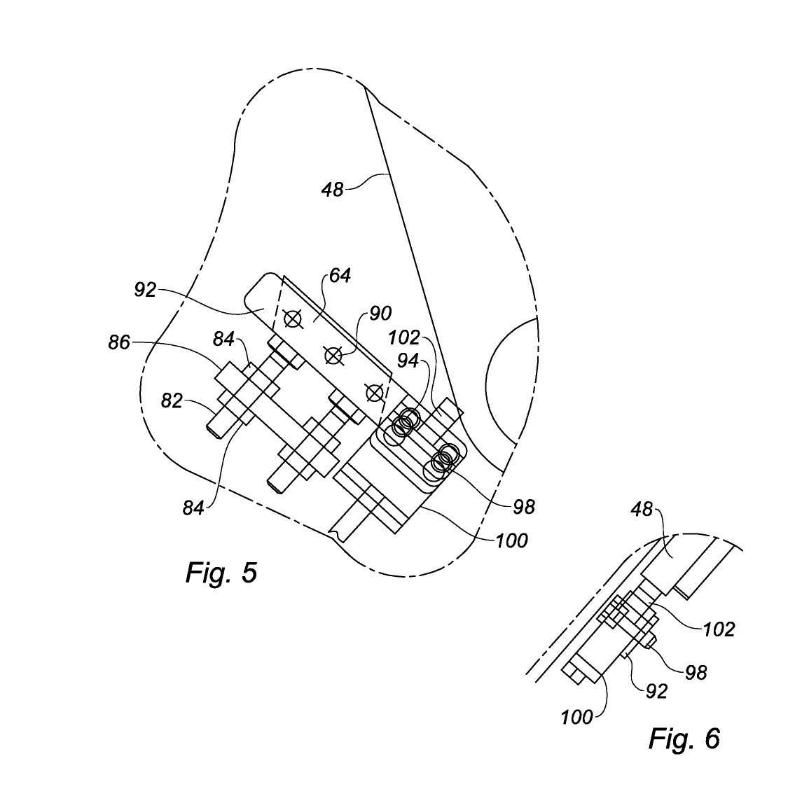

The abutment 64 detailed in FIGS. 5 and 6, bears at the rear side on two parallel setting screws 82, disposed perpendicularly with respect to the bearing of this abutment, and each inserted in a hole of a fixed support bar 86, with a nut 84 clamping this bar on each side.

In this manner, it is possible to perform an accurate setting of the position and of the inclination of the abutment 64 by setting the position of each screw 82, so as to obtain a bearing of the crank 48 distributed over the length of this abutment when the body of the vehicle is in the high position.

The end-of-travel position of the crank 48 is accurately set by the abutment 64 so as to obtain a tight engagement of the finger 50 in the recess 56 of the hook 30, with very few clearances avoiding beatings which could cause noises and wear.

The abutment 64 supports, by three screws 90, an elongated metal sheet 92 disposed in the plane of the crank 48, an end of which protruding from one side of this abutment presents two elongated holes 94 perpendicular to the bearing of the abutment, receiving two fastening screws 98 of an electrical contactor 100. The electrical contactor includes a detection finger 102 protruding from the bearing face of the abutment 24, which receives the push of the crank 48 when it reaches the end-of-travel of this abutment.

The electrical contactor 100 forms a position sensor which is easily set thanks to the oblong holes 94 ensuring its fastening, so as to accurately detect the position of the crank 48 at the end-of-travel allowing the descent of the hook 30, and therefore the locking of the lowering device with the body in the high position. Thus, a safety on the locking of this device is obtained based on the signal of the electrical contactor 100, which may in addition indicate the side of the vehicle which is not locked by choosing two different signals.

When fastening the position sensor 100 on the abutment 64, it is possible to set the position of this abutment by means of its setting screws 82, without modifying the relative position of the sensor with respect to the abutment.

Advantageously, it is possible to use an electrical contactor 100 which opens the contact when detecting the end-of-travel of the crank 48, and branch it in parallel to an electric contact of the handbrake of the vehicle which, in turns, opens at the end-of-travel when this handbrake is released. The signal intended to inform the driver that the handbrake is in the clamped position is then obtained, given by a light or a noisemaker, which also signals that the vehicle is not ready to go, with the lowering device not locked in the high position.

As a variant, it is possible to use any other type of sensor for detecting the end-of-travel of the crank 48, in particular a position sensor using a Hall effect technology. As a variant, it is also possible to use instead of the hydraulic cylinder 10 any other actuation system for pulling up the body of the vehicle, in particular an electric actuator.

1. A device for lowering the body of a vehicle, including an arm receiving the hub of a wheel of an axle supporting the body of the vehicle, this arm being pivotally fastened on the axle so as to raise or lower the hub relative to the axle under the effect of an actuator, this device including a locking system which automatically blocks the pivot arm in its end-of-travel position with the body raised, characterized in that it includes a means for detecting the end-of-travel position of the pivot arm with the body raised.

2. The lowering device according to claim 1, wherein the detection means establishes an electric current when detecting the end-of-travel position of the pivot arm.

3. The lowering device according to claim 1, wherein the detection means is fastened on the lowering device by a position setting system.

4. The lowering device according to claim 3, wherein the position setting system includes elongated holes receiving fastening screws of the detection means, which extend substantially in the direction of motion of the portion linked to the pivot arm, when it comes over this detection means.

5. The lowering device according to claim 1, wherein the detection means is fastened on an adjustable abutment forming the end-of-travel abutment of the pivot arm.

6. The lowering device according to claim 1, wherein the detection means includes a detection finger which receives the push of an element linked to the pivot arm when it reaches the end-of-travel.

7. The lowering device according to claim 1, wherein it includes a shaft disposed transversally in the vehicle, supporting at its end facing outwardly of the vehicle the pivot arm, and at its inner end a crank receiving the motion of the actuator and acting on the detection means.

8. The lowering device according to claim 1, wherein the locking system includes an additional detector which detects its position achieving the blocking of the pivot arm at the end-of-travel.

9. The lowering device according to claim 1, wherein it includes a control cable which opens the locking system.

10. A motor vehicle equipped with a device for lowering the body of this vehicle, wherein this lowering system is in accordance with claim 1.

11. The motor vehicle according to claim 10, wherein the detection means is connected to an electric circuit for checking the handbrake of the vehicle in the clamped position, so as to operate the signal of this handbrake intended to the driver when the end-of-travel position of the pivot arm is not detected.
